(19) United States
(12) Patent Application Publication
(10) Pub. No.: US 2004/0209085 A1
(43) Pub. Date: Oct. 21, 2004

(54) Gluing plastic extrudates to material surfaces

(76) Inventors: Amin Erb, Detmold (DE); Jurgen Schrodel, Detmold (DE); Christian Terfloth, Detmold (DE)

Correspondence Address: CONNOLLY BOVE LODGE & HUTZ LLP, SUITE 800, 1990 M STREET NW, WASHINGTON, DC, 20036-3425, US

(21) Appl. No.: 10/488,609

(22) PCT Filed: Aug. 3, 2002
(86) PCT No.: PCT/EP02/08672

(30) Foreign Application Priority Data
Sep. 5, 2001 (DE) 101 43 599.1
Sep. 10, 2001 (DE) 101 44 524.5

(51) Int. Cl. B32B 27/00

(52) U.S. Cl. 428/423.1; 428/424.4; 156/244.27

(57) ABSTRACT

The invention relates to methods for joining or assembling thermoplastic synthetic extrudates, especially in the form of a billet or band, to material surfaces, preferably by means of gluing, in addition to objects produced according to said methods. The invention also relates to the use of special adhesives and adhesive compositions for gluing thermoplastic synthetic extrudates to material surfaces.

The present invention relates to permanent joining of thermoplastic synthetic extrudates to material surfaces, preferably by gluing. More specifically, the present invention relates to joining or assembling of thermoplastic synthetic extrudates, in particular in the billet or band form, to material surfaces, preferably by gluing. In addition, the present invention relates to the use of special adhesives and adhesive substances for the above-named applications. In the same manner, the present invention relates to objects produced according to this method.

In particular, the present invention relates to a method for gluing of extruded edge bands to narrow sides or edges of materials, for instance wood. A further aspect of the present invention is the manufacturing of picture frames formed three-dimensionally by extrusion of thermoplastic material substances in suitable carriers. Another aspect of the present invention relates to consolidation of edges of materials, in particular wood.

During mounting of so called edge bands (for instance PVC edge bands) to narrow sides or edges of pieces made of wood (for instance MDF [median thickness fiber] plates or clamping plates, the procedure is generally carried out in such a way so that the narrow side of the material to be attached is provided with an adhesive and the edge band itself is then attached to it. According to the customary procedure based on existing technology, the manufacturing of the edge band takes place independently of the process wherein the edge bend is installed onto the edge of the construction material. This, however, is connected with a number of problems: On the one hand, a sufficient amount must be deposited on the edge, which can lead to logistic problems. On the other hand, an individual edge band may not fit due to its structure and its profile the edge structure in question because it is made from prefabricated material, which cannot be shaped any more as is.

In order to avoid the disadvantages described above, apparatuses and methods have been proposed in international open patent publications WO 00/53387 A1 and WO 00/53399 A1, whose complete content is hereby included by way of reference. Their purpose is to combine the manufacturing of extruded billets (for example for edge bands) for material surfaces, in particular for narrow material surfaces or edges, on the one hand with shaping, and on the other hand to combine the processes, that is to say to join permanently the billet, which is obtained still warm and thus moldable from the extrusion process from a synthetic material—after an adhesive has been deposited on the material surface to be coated—directly after its manufacturing while it is being shaped, to the material surface.

For instance international open patent publication WO 00/53399 A1 describes an apparatuses for the manufacturing of a oblong, synthetic object having the form of an extruded billet, wherein this apparatus comprises an extrusion means for extruding synthetic billets, as well as a rotatable or turning shaping means, enabling the shaping of an extruded billet with a desired cross-sectional profile. The shaping means involves in particular a slide or tread roller, or a number of rolls working together, provided with corresponding shapes, recesses, or projections, used in order to impart the desired form or the desired profile to the extruded billets. In addition, the apparatus according to WO 00/53300 A1, can be provided with a transport means for a material onto which the extruded billet is to be deposited, as well as with a coating device for an adhesive, whereby the extrudate is fixed to the material. The method described therein is suitable in particular for gluing of edge bands with an adhesive to narrow sides of materials, in particular wood, as well as for consolidation of edges and for manufacturing of picture frames.

Further, WO 00/53399 A1 describes a procedure for the manufacturing of an oblong synthetic object, wherein first, a billet-shaped extrudate that is made of a synthetic plastic material is manufactured, and this extrudate is then shaped by means of rotatable or turning shaping means,

in particular with one or several rolls, into a billet, strip, band, or border having the desired cross-sectional profile. The shaping is in this case carried out in such a way so that the extruded billet is pressed onto or forced against the material while it is still in the warm status with a shaping device, in particular with a roll or rolls. The adhesion between the extruded plastic strips and the materials is in this case achieved while the region of the material which is to be provided with the formed extrudate is coated with an adhesive layer. Therefore, an adhesive must be first deposited onto the narrow surface of the wood material that is to be coated with it, so that the plastic billets that are extruded thereafter display a sufficient adhesion to the material, in particular wood material.

International open patent application WO 00/53387 A1 describes an apparatus for applying a plastic edge strip to the edge or narrow side of a plate-shaped material carrier, for instance a wooden board, a clamping plate or the like, wherein the apparatus comprises an extrusion means for extrusion of a plastic billet to the edge or narrow side of the material, and a shaping means, with which the extruded plastic billets can be formed to a desired profile. In addition, the apparatus can also comprise a transport means for transporting the material, as well as a depositing means for the adhesive, in order to bond permanently the plastic billets with the material. The shaping means comprises in particular a rotatable or turning roll or roller, or several rotatable or turning rolls or rollers, which press the edge strip to the edge of the material and impart the desired form to it.

Moreover, WO 00/53387 A1 describes a corresponding method for applying an extruded plastic edge billet to the edge or narrow side of a plate or of a board-like workpiece by the extrusion of a plastic billet directly onto the edge of the workpiece, and shaping of the extruded billet with a shaping means; wherein to achieve permanent joining of the edge band to the workpiece, the latter is first coated with an adhesive on the surface to be coated,

which ensures bonding between the edge band and the workpiece. Heat-activated, solvent-based polyurethane adhesives are cited as suitable adhesive systems in WO 0053387.

Several disadvantages, however, are connected with the adhesive systems named therein: On the one hand, similar solvent-based systems cannot be used with edge extrusion inline due to the danger of inflammation. Moreover, similar adhesives substances containing a solvent represent a clear environmental burden which is posed by volatile organic substances, so called “VOC's” [volatile organic compounds], and they can possibly also endanger the production personnel, which is exposed to these VOC's during the production.

A task of the present invention is therefore to provide a method for permanent joining of extruded plastic profiles to material surfaces, which avoids the disadvantages described above. Such a method is suitable in particular for joining of edge bends to the narrow sides of workpieces made in particular from wood, for consolidation of edges, and for manufacturing of picture frames.

An additional task of the present invention is in particular to build upon the methods described in WO 00/53387 A1 and WO 00/533099 A1 and particularly to optimize the application or carrying out of these methods.

A first object of the present invention thus relates to a method for joining a plastic extrudate to a material surface, wherein an extruded thermoplastic synthetic billet is applied, preferably immediately after its manufacture while it is still in the moldable, preferably warm state, to a workpiece surface, coated first in the region in which the extruded billet is to be applied with an adhesive. Thereafter, the applied billet material is pressed onto the material surface or forced against the material surface with a shaping means, in particular with one or several rolls, so that shaping of the billet material takes place at the same time, wherein the applied adhesive is selected from a group comprising

(i) aqueous polyurethane dispersions, which can be optionally ionically stabilized, and

(ii) solvent-free thermoplastic hot-melt adhesives based on polyurethanes and/or polyamides.

According to an embodiment of the method in accordance with the invention, aqueous polyurethane dispersions that are per se known, and which can be optionally ionically stabilized, can be employed. Due to their manifold adhesion spectrum, polyurethane dispersions are suitable for gluing of differing substrates or for processing of the surfaces for the gluing method according to this invention.

The optionally ionically stabilized, aqueous polyurethane dispersions can be thixotropic and they can display viscosities (Brookfield, 20 EC) in the range from 500 to 50,000 mPas, in particular 1,000 to 10,000 mPas, preferably 2,000 to 3,000 mPas, while the range from 2,200 to 2,500 mPas is particularly preferable. The coating is preferably performed with optionally ionically stabilized, aqueous polyurethane dispersions in the amounts of up to 10 g/m² (dry weight).

The optionally ionically stabilized, aqueous polyurethane dispersions can also contain other components, in particular wetting agents, thickening agents, fillers, crosslinking agents and/or silicic acid. Crosslinking agents promote crosslinking of the surface on which the adhesive is applied. Thickening agents serve to increase the viscosity and consequently to provide better handling characteristics. Silicic acid serves to increase the size of the surface of the formed film. Providing the polyurethane dispersions with a silicic acid to increasing the surface of the film has proven to be advantageous in an experiment, but not absolutely necessary. The employment of crosslinking agents such as for example isocyanate crosslinkers for the polyurethane dispersions is also possible, while again not necessary.

Examples of polyurethane dispersions that can be used in accordance with the method of the invention are products Jowat® Primer 409.10 and 409.19, manufactured by the Jowat Lobers and Frank GmbH & Col, KG, Germany; these examples involve formulations based on polyurethane dispersions.

The use of aqueous polyurethane dispersions for the method according to the invention is particularly advantageous when the material is a wooden material because in this case, the dispersion, in particular the water of the dispersion, can be quickly absorbed into the wood structure. Another advantage of the use of aqueous polyurethane dispersions is the fact that that in comparison to other adhesive systems, only a relatively thin coating is required because this system is present as an aqueous dispersion, which can be employed as is with conventional methods that are per se known in order to achieve an equivalent coating, so that polishing of the adhesive layer is no longer required.

When the method according to the invention is used for example for extruded edge bands with narrow sides or edges of wood materials in plate or board forms for gluing by means of polyurethane dispersions used according to this invention, an edge band extrudate having a thickness of for example 3 mm is sufficient for gluing with an adhesive film with a thickness of only about 1 μm to about 50 μm thick (dry weight).

According to a second embodiment of the method in accordance with this invention, per se known solvent-free thermoplastic hot-melt adhesives based on polyurethanes and/or polyamides are employed.

The object of this embodiment is also the use of a thermoplastic system for adhesion promoting finishing of the material surfaces, in particular for wood materials. Good results were displayed when thermoplastic materials that are based on polyurethane or polyamide were used. The processing of these materials occurs with methods and devices that are in themselves known, for example with melting and roll coating devices for hot-melt adhesives (for example in particular in the case of polyamide hot-melt adhesives), or by using extrusion machines that are in themselves known. The advantage of these thermoplastic primers or adhesive substances is in comparison to polyurethane dispersions on the one hand the fact that drying is no longer required before the application of the thermoplastic extrudate, and on the other hand the ability to reduce the thickness of the layer of the thermoplastics extrudate. This is of particular significance as far as the economical characteristics of the system are concerned. The thermoplastic adhesion promoting agent or adhesive substance leads, unlike polyurethane dispersions, to a flat surface layer on the material.

In particular when clamping plates are used, this will significantly reduce the representation (transmission) of the clamping structure onto the edge band surface, because the adhesive substance flattens also the structure surface. This makes it possible to realize thinner coating weights relative to the extrudate, that is to say to reduce the coating weight of the extrudate, which guarantees a higher inline throughput with a continuous production line.

When according to the method of this invention, for example extruded edge bands are glued to narrow sides or edges of wood materials in plate or board forms by means of the hot-melt adhesive according to this invention that is based on polyurethanes and/or polyamides, an adhesive film thickness (dry weight) of a hot-melt adhesive of only about 50 μm to 350 μm is sufficient for gluing of for instance edge bands, preferably about 150 μm to about 300 μm, while using a reduced thickness of the edge band extrudate of less than 3 mm, in particular less than 2 mm, preferably less than 1 mm.

This embodiment, wherein a solvent-free thermoplastic hot-melt adhesive based on polyurethanes and/or polyamides is used, is characterized by processing temperatures in the range from 160 EC to 220 EC, preferably 175 EC to 200 EC.

The employed solvent-free hot-melt adhesives based on polyurethane have a melt index (MFI, 180 EC, 10 kg) from 10 to 200 g/10 min and a softening range from 100 EC to 180 EC, preferably 130 EC to 170 EC.

The employed solvent-free thermoplastic hot-melt adhesives based on polyamides have particular viscosities (Brookfield) at 180 EC in the range from 7,000 to 9,000 mPas, at 190 EC in the range from 5.000 to 7,000 mPas and at 200 EC in the range from 3,000 to 5,000 mPas.

An example of a solvent-free thermoplastic hot-melt adhesive according to the invention based on polyurethane is Jowatherm® EP 18299.00, distributed by the Jowat Lobers and Frank Gmbh & Co., KG, Germany.

The extrudate applied according to the invention relates in particular to a thermoplastic synthetic material based on polyvinyl chloride (PVC), polystyrene, ABS (acrylonitrile-butadiene-styrene terpolymer) and/or polyurethane.

The material can be a plastic material or wood. In case of materials made from synthetic materials, it can be also an extrudate.

It is, however, preferable when a wood material in the form of a board or a plate is used, in particular a wood plate, a clamping plate, and MDF [medium thickness fiber] plate, or the like. The extruded and formed billet material is in particular an edge band or an edge strip, which is glued to a narrow side or edge of a board or plate-shaped material.

The use of a special adhesive substance in accordance with the invention makes it possible to perform the method of this invention continuously and/or inline.

In a special refinement of the present invention, the method is realized in accordance with the invention according to WO 00/53387 A1 or WO 00/53399 A1. Reference is made with respect to further details relating to the variants of the method to the embodiments above, as well as to international open patent publications WO 00/53387 A1 or WO 00/53399 A1, whose entire content is hereby included by way of reference.

Another object of the present invention are objects manufactured in accordance with the method of the invention. These objects are materials having a material surface that is partially glued to an extruded and shaped thermoplastic synthetic billet, wherein the systems described above are employed as adhesive substances. In particular, this material is a wood material having the form of a board or a plate, especially a wooden clamping plate, a pressboard clamping plate, a MDF [medium thickness fiber] plate or the like, glued on its narrow side(s) or edge(s) to the extruded and shaped billet material having the form of an edge band or an edge strip. In this case, the workpiece is glued at its narrow sides or edges to a three-dimensionally shaped profile made of plastic, wherein the shaping can be achieved individually.

According to a third embodiment form of the method in accordance with the invention, the extruded material itself is formed hot or heat-setting [tacky under heat]. According to this embodiment form, the invention relates to a method for joining a plastic extrudate with a material surface, wherein an extruded thermoplastic synthetic billets is applied, preferably directly after its manufacture, while it is still in the a shapeable, in particular warm, status, to a material surface. Thereafter, the applied billet material is forced or pressed with a shaping means, in particular with one or several rolls, against the material surface, preferably onto its narrow side(s) or edge(s). This results in a simultaneous shaping of the billet material, whereby the plastic material employed is a plastic material becoming tacky under heat, in particular a heat-setting plastic material that is based on thermoplastic polyurethane, if necessary mixed with other polymers and/or additives.

The permanent adhesive joining is ensured in this embodiment form by the use of a heat-setting extrudate or edge band. During the heat-setting phase, it must be possible for a similar extrudate or edge band to develop a good and permanent adhesion to the material surface. This requires rapid cooling with a small shrinkage amount, so that the extruded edge band can be further processed inside the machine. The type of the coated wood material being used should be provided with edge bands having at least the same mechanical characteristics as those of present PVC edge bends or the like.

In a special refinement, this variant of the method in accordance with this invention can be also carried out according to the method type of WO 00/53387 A1 or WO 00/53399 A1. Further details of this variant of the method can be obtained from the reference provided in the embodiments above, as well as from international open patent publications WO 00/53387 A1 or WO 00/53399 A1, whose complete content is hereby included by way of reference.

Another object of the present invention are according to this third variant of the method objects manufactured in accordance with the method of the invention. These objects relate to materials, in particular wood materials in the form of a board or plates, wherein the material surfaces are partially glued, in particular in the region of their narrow side(s) or edge(s) of the workpiece, to an extruded and shaped thermoplastic synthetic billet, in particular having the form of an edge band or an edge strip, and the thermoplastic synthetic material is a heat-setting plastic material, in particular a heat-setting plastic material based on thermoplastic polyurethane, which can be mixed with other polymers and/or additives, while the bonding occurs preferably without additional adhesive substances.

The figure shows:

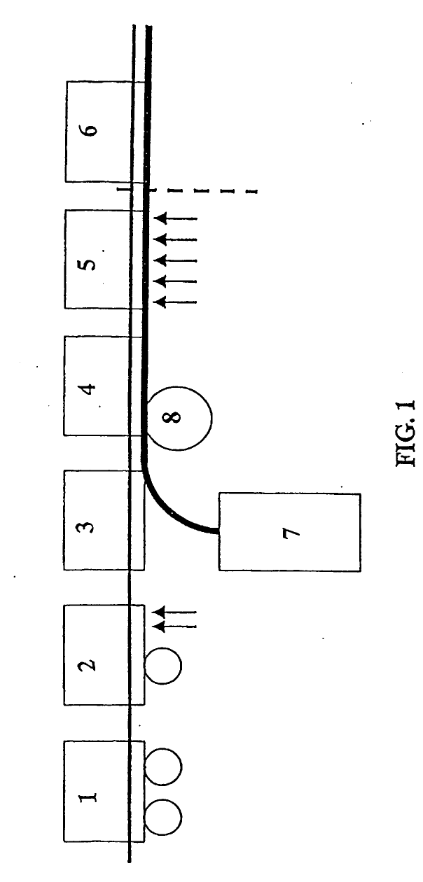

FIG. 1 a schematic representation of the operating sequence of the method according to the invention.

FIG. 1 indicates the operating sequence of the method according to the invention. First, during (1), a workpiece which is to be glued to an extrudate is formatted. Next, during (2), coating with the adhesive substance is carried out; this stage of the method is omitted when a hot or heat-setting extrudate is employed. During stage (3) occurs the manufacturing of the extrudate onto which gluing is to be performed in an extruder (7), wherein this extrudate is then applied in (4) directly after it has been manufactured while it is still in the warm, shapeable status to the material surface and pressed onto or forced against the material surface with a shaping means (8), so that shaping of the extrudates takes place at the same time. A cooling operation is initiated during (5), and finally in (6), the separation and formatting of the completed workpiece occurs.

Another object of the present invention is also a method for the manufacturing of three-dimensional profiles on a material surface,

wherein an extruded thermoplastic synthetic billet, preferably directly after its manufacture, while it is still in the shapeable, in particular warm status, is applied to a material surface, and the applied billet material is then pressed onto or forced against the material surface with a shaping means, in particular with one or several rolls, so that shaping of the billet material resulting in the formation of a three-dimensional profile will take place at the same time, wherein the extrudate is a homogenous mixture, which contains:

(i) at least one heat-setting thermoplastic substance, in particular based on ethylene/vinyl acetate (EVA) copolymers, polyamides, polyurethanes and/or polyolefins, in particular (amorphous) poly-α-olefins, and preferably in the form of a hot-melt adhesive substance,

(ii) filler particles based on inorganic oxides, silicates, carbonates and/or sulfates such as aluminum oxides, silicon dioxides, barium sulfates, calcium carbonates, alkaline oxides and alkaline earth oxides, titanium oxides, iron oxides and the like, wherein the amount of the filler particles in particular is from 30 weight % to 80 weight %, preferably 50 to 70 weight %, per the total mixture to be applied, and/or, in particular when the filler particles are preferably rod-shaped, but also spherical or almost spherical, with a median particle size in the range from about 3 μm to about 20 μm, preferably about 4 μm to about 10 μm,

(iii) optionally also other ingredients and additives, in particular resins, such as aromatic hydrocarbon resins and modified synthetic resins, preferably liquid rosin resins, and/or auxiliary agents and additive agents such as waxes and the like.

According to the method of this invention can be manufactured for example borders or picture frames. The mixtures are applied in hot or heat-setting status and harden after cooling to form the desired 3D profiles.

Suitable materials or carriers onto which the extruded mixtures can be applied are in particulars synthetic materials such as polyvinyl chloride (PVC), polysterene, ABS [acrylonitrile-butadiene-styrene] and/or polyurethane, but also wood.

The material or carrier surfaces can be optionally also pretreated, for example by plasma activation, primer coating, corona pretreatment, etc. This leads to improved adhesion depending on the circumstances.

In a special refinement of the method in accordance to the invention, the method type is realized according to WO 00/53399 A1.

The mechanical requirements on the surfaces are significantly lower in comparison to edge extrusions. Suitable quantities of thermoplastic substances are based on the use of the EVA [ethylene/vinyl acetate] hot-melt adhesive substances which are mixed with inorganic fillers.

EVA hot-melt adhesive substances are preferably employed, which are known in the field of edge gluing. Such system are based for instance on ethylene/vinyl acetate copolymers, optionally mixed with aromatic carbohydrate resins and/or modified natural resins, in particular liquid rosin resins, and optionally also with per se known auxiliary and aggregate materials such as waxes. Particularly suitable materials according to the invention have processing temperatures in the range from 160 to 230 EC, preferably 175 to 215 EC (for example Jowatherm® 280.40 or 280.41, distributed by the firm Jowat Lobers and Frank GmbH & Col, KG, Germany).

Suitable inorganic fillers of the above-named type are distributed for example by the Sphere-Fill Company, South Africa, under the designation Plasfill®-5. Particularly preferred is the use of inorganic fillers that are based on silicon dioxides and/or aluminum silicates, optionally mixed also with other inorganic oxides. The content of such fillers in the finished thermoplastic mixtures is normally 30 to 80 weight %, in particular 50 to 70 weight %.

Another object of the present invention are the objects or three-dimensional profiles (for instance of picture frames or borders, which are manufactured according to this procedure. The objects or three-dimensional profiles can be then also refined (for example by varnishing or applying to them or covering them with a decorative foil).

In addition, surprisingly enough, it was also found that the above-mentioned mixture of a thermoplastic material and inorganic fillers is perfectly suitable for an edge consolidation agent. This application involves compression, for instance of narrow surface or edges of a clamping plate, so that they become smoothed; while a consequent covering of a clamping plate equipped in this manner, for example with decorative materials represents a typical use, without pressing the wood structure of the narrow side or edge through onto the decorative surface (transmission). In particular when thin decorative paper materials or decorative foils are used, it is the possible to avoid having to use an expensive MDF [medium thickness fiber] plate. The formulation principle of the thermoplastic material for edge consolidation is the same as with picture frames.

Another object of the present invention is thus a method to consolidate narrow sides or edges of materials having the form of plates or boards, in particular made of wood, such as wooden clamping plates, pressboard clamping plates, MDF plates or the like, wherein a homogenous mixture is applied onto the narrow band(s) or edge(s), which contains:

(i) at least a hot-melt thermoplastic material, in particular based on ethylene/vinyl acetate (EVA) copolymers, polyamides, polyurethanes and/or polyolefins, in particular (amorphous) poly-α-olefines, and preferably in the form of hot-melt adhesives,

(ii) filler particles, based on inorganic oxides, silicates, carbonates and/or sulfates such as aluminum oxides, silicon dioxides, barium sulfates, calcium carbonates, alkaline oxides and alkaline earth oxides, titanium oxides, iron oxides and the like, in particular with an amount of filler particles in the range of 30 weight % to 80 weight %, preferably 50 to 70 weight %, per the total mixture to be applied, and/or, in particular when the filler particles are preferably rod-shaped, but also spherical or almost spherical, with a median particle size in the range from about 3 μm to about 20 μm, preferably about 4 μm to about 10 μm, and

(iii) optionally other ingredients and additives, in particular resins, such as aromatic hydrocarbon resins and modified synthetic resins, preferably liquid rosin resins, and/or auxiliary agents and additive agents such as waxes and the like.

The application of the above-named mixture is performed according to per se know methods, in particular by extrusion and nozzle or roller furnishing, wherein nozzle furnishing is preferred. The mixture can be applied in this case,with a layer thickness up to 1 mm or even more.

In order to achieve an optimal edge consolidation, the applied mixture is then compressed in or forced in while being still in the shapeable, in particular warm, status, advantageously into the porous wood or edge structure. This is carried out with devices that are per se known and frequently used by persons in the art, for example by means of finish rolls.

The formulation or mixture employed for the edge consolidation procedure according to the invention is the same as the one in the above-described method for producing three-dimensional profiles, such as for example picture frames, on a material surface. Details of the formulation or mixtures thus can be obtained from the explanations above.

Another object of the present invention are also objects that are manufactured in this manner, that is to say materials having the form of plates or boards, in particular made of wood, such as clamping plates, pressboard clamping plates, MDF [medium thickness fiber] plates or the like, wherein a homogenous mixture having a uniform layer thickness is applied onto the narrow side(s) or edge(s), which contains the already named ingredients (i) through (iii):

(i) at least a hot-melt thermoplastic material, in particular based on ethylene/vinyl acetate (EVA) copolymers, polyamides, polyurethanes and/or polyolefins, in particular (amorphous) poly-α-olefines, and preferably in the form of hot-melt adhesives,

(ii) filler particles, based on inorganic oxides, silicates, carbonates and/or sulfates such as aluminum oxides, silicon dioxides, barium sulfates, calcium carbonates, alkaline oxides and alkaline earth oxides, titanium oxides, iron oxides and the like, in particular with an amount of filler particles in the range of 30 weight % to 80 weight %, preferably 50 to 70 weight %, per the total mixture to be applied, and/or, in particular when the filler particles are preferably rod-shaped, but also spherical or almost spherical, with a median particle size in the range from about 3 μm to about 20 μm, preferably about 4 μm to about 10 μm, and

(iii) optionally also other ingredients and additives, in particular resins, such as aromatic hydrocarbon resins and modified synthetic resins, preferably liquid rosin resins, and/or auxiliary agents and additive agents such as waxes and the like,

wherein the applied coating mixture can be advantageously compressed in or forced into the porous structure, in particular wood structure, of the edge(s) or narrow side(s) of the workpiece.

Other refinements and variations of the present invention will be clearly evident and can be easily realized by a person in the art upon reading of the patent document without deviating from the scope of the present invention. The present invention is illustrated by the following embodiment examples, which, however, should not be interpreted as limiting in any way the invention.

### EMBODIMENT EXAMPLES

### Example 1

### Mounting an Edge Band onto the Narrow Side of Compressed Wood

A polyamide hot melt adhesive having a processing temperature of 180 to 190 EC (Jowatherm® 211.60, distributed by the firm Jowat Lobers and Frank GmbH & Co. KG Germany) was applied with a uniform layer thickness of about 100 μm, each time onto an edge of clamping plates having the dimensions 30 cm×30 cm×3 cm, in an apparatus, such as the one described in WO 00/53387 A1. The application was performed in the usual manner by using melting and roller coating.

After that, the adhesive layer is coated with an extruded PVC billet while it is still in the warm or shapeable status and pressed onto the workpiece edge with a rotatable or turning roll while compression and shaping is applied at the same time so that an edge band is formed having a uniform profile with a thickness of 2.5 mm. The entire product is then allowed to cool off. The overhanging ends of the edge bands are cut off.

The procedure is carried out inline and continuously. The resulting clamping plates, glued onto one edge or narrow side and at the same time to a PVC edge band, which is 2.5 cm thick and 3 cm wide, can be utilized for example in the furniture industry.

### Example 2

### Edge Consolidation on Wooden Clamping Plates

During continuous operations, a molten, heat-setting mixture having a uniform layer thickness of about 1 mm is applied to the edges or narrow sides of clamping plates, measuring 25 cm×25 cm×2 cm, containing an EVA [ethylene vinyl acetate] hot-melt adhesive having a softening range of about 100 EC and a processing temperature ranging from 180 to 200 EC, (Jowatherm® 280.40 or 280.41, distributed by the firm Jowat Lobers and Frank GmbH & Co., KG, Germany), as well as filler particles based on inorganic oxides (Plasfill®-5, distributed by the firm Sphere-Fill, South Africa).

The application is carried out by means of an extrusion. Various mixtures having different weight ratios were applied, namely with weight ratios between the EVA [ethylene vinyl acetate] hot-melt adhesive/fillers of 50:70, 50:60 and 50:50.

The substance, which was still hot and shapeable, was then pressed into or forced against the wood structure. After cooling and hardening of the applied mixture, clamping plates with consolidated narrow sides were formed, which can be employed in particular in the furniture industry wherein they can be used as a replacement for expensive MDF [medium thickness fiber]. The edges or narrow sides consolidated in this manner displayed good Shore hardness values.

### Example 3

### Manufacture of Three-Dimensionally Formed Profiles in the Form of a Picture Frame

The mixtures described in Example 2 were used in order to manufacture three-dimensional profiles in the form of a picture frame. The mixtures used in this case were extruded according to Example 2 with an apparatus such as the one described in WO 00/53399 A1, on a polystyrene carrier frame and pressed onto the carrier with a rotatable roll while they were still in the warm, shapeable status, which at the same time resulted in the formation of the desired profiled due to the profile of the roll. The resulting three-dimensional profiles formed after cooling off on a polystyrene carrier can be used as picture frames.

1-22. (Canceled).

23. A method for joining a synthetic extrudate to a surface, the method comprising:
providing a substrate having a billet-contact surface;
providing an adhesive to said surface;
extruding a thermoplastic billet directly onto said substrate, said billet being in a warm shapeable state;
contacting said billet to said adhesive on said surface; and
pressing said billet against said surface with a billet-shaping means thereby shaping said billet; wherein said adhesive is selected from the group consisting of aqueous polyurethane dispersions, ionically stabilized aqueous polyurethane dispersions, solvent-free thermoplastic polyurethane hot-melt adhesives, solvent-free thermoplastic polyamide hot-melt adhesives.

24. The method for joining a synthetic extrudate to a surface, according to claim 23, wherein said billet comprises a thermoplastic material selected from the group consisting of ethylene/vinyl acetate copolymers, polyamides, polymethanes, polyolefins, polyvinyl chloride, polystyrene, acrylonitrile butadiene styrene, polyurethane, and mixtures thereof.

25. The article of manufacture, according to claim 24, wherein said polyolefin is an amorphous poly-α-olefin.

26. The article of manufacture, according to claim 23, wherein said thermoplastic is a hot-melt adhesive.

27. The method for joining a synthetic extrudate to a surface, according to claim 23, wherein said substrate is selected from the group consisting of synthetic materials and wood.

28. The method for joining a synthetic extrudate to a surface, according to claim 23, wherein said substrate has the general form of a board or plate having at least one of a narrow side and edge.

29. The method for joining a synthetic extrudate to a surface, according to claim 26, wherein said plate is a form selected from the group consisting of a clamping plate, a pressboard clamping plate, and a medium thickness fiber plate.

30. The method for joining a synthetic extrudate to a surface, according to claim 23, wherein said aqueous polyurethane dispersion is thixotropic.

31. The method for joining a synthetic extrudate to a surface, according to claim 23, wherein said aqueous polyurethane dispersion has a Brookfield viscosity in the range of from about 500 to about 50,000 mPas.

32. The method for joining a synthetic extrudate to a surface, according to claim 23, wherein said aqueous polyurethane dispersion has a Brookfield viscosity in the range of from about 1000 to about 10,000 mPas.

33. The method for joining a synthetic extrudate to a surface, according to claim 23, wherein said aqueous polyurethane dispersion has a Brookfield viscosity in the range of from about 2000 to about 3,000 mPas.

34. The method for joining a synthetic extrudate to a surface, according to claim 23, wherein said aqueous polyurethane dispersion has a Brookfield viscosity in the range of from about 2,200 to about 2,500 mPas.

35. The method for joining a synthetic extrudate to a surface, according to claim 23, wherein said aqueous polyurethane dispersion is applied in an amount up to about 10 g/m².

36. The method for joining a synthetic extrudate to a surface, according to claim 23, wherein said aqueous polyurethane dispersion further comprises materials selected from the group consisting of wetting agents, thickening agents, fillers, crosslinking agents, resins, waxes, and silicic acid.

37. The method for joining a synthetic extrudate to a surface, according to claim 23, wherein said hot-melt has a processing temperature of from about 160° C. to about 220° C.

38. The method for joining a synthetic extrudate to a surface, according to claim 23, wherein said hot-melt adhesive has a processing temperature of from about 175° C. to about 200° C.

39. The method for joining a synthetic extrudate to a surface, according to claim 23, wherein said polyurethane hot-melt adhesive has a melt index of from about 10 to about 200 g/10 min and a softening range of from about 100° C. to about 180° C.

40. The method for joining a synthetic extrudate to a surface, according to claim 23, wherein said polyurethane hot-melt adhesive has a melt index of from about 10 to about 200 g/10 min and a softening range of from about 130° C. to about 170° C.

41. The method for joining a synthetic extrudate to a surface, according to claim 23, wherein said polyamide hot-melt adhesive has a Brookfield viscosity, measured at 180° C. of from about 7000 mPas to about 9000 mPas.

42. The method for joining a synthetic extrudate to a surface, according to claim 23, wherein said polyamide hot-melt adhesive has a Brookfield viscosity, measured at 190° C. of from about 5000 mPas to about 7000 mPas.

43. The method for joining a synthetic extrudate to a surface, according to claim 23, wherein said polyamide hot-melt adhesive has a Brookfield viscosity, measured at 200° C. of from about 3500 mPas to about 5500 mPas.

44. The method for joining a synthetic extrudate to a surface, according to claim 23, wherein said synthetic material is selected from the group consisting of polyvinyl chloride, polystyrene, acrylonitrile-butadiene-styrene, and polyurethane.

45. The method for joining a synthetic extrudate to a surface, according to claim 23, wherein said billet-shaping means comprises at least one roll.

46. The method for joining a synthetic extrudate to a surface, according to claim 23, wherein said billet-shaping means imparts a three-dimensional profile to said billet.

47. The method for joining a synthetic extrudate to a surface, according to claim 36, wherein said filler is an inorganic mineral selected from the group consisting of oxides, silicates, carbonates, and sulfates.

48. The method for joining a synthetic extrudate to a surface, according to claim 23, wherein said substrate surface is provided an adhesion-enhancing treatment.

49. The method for joining a synthetic extrudate to a surface, according to claim 48, wherein said adhesion-enhancing treatment is selected from the group consisting of plasma activation, primer coating, and corona discharge.

50. The method for joining a synthetic extrudate to a surface, according to claim 23, wherein said billet is formed into at least one of a band and a strip and said band or strip is adhered to at least one of said narrow side and edge.

51. The method for joining a synthetic extrudate to a surface, according to claim 23, wherein said method is an inline, continuous process.

52. An article of manufacture comprising:
a substrate having a billet-contact surface;
a layer of an adhesive applied to said substrate;
an extruded, thermoplastic, shaped billet adhered to said surface by means of said adhesive, wherein said adhesive is selected from the group consisting of aqueous polyurethane dispersions, ionically- stabilized aqueous polyurethane dispersions,
solvent-free thermoplastic polyurethane hot-melt adhesives, solvent-free thermoplastic polyamide hot-melt adhesives.

53. The article of manufacture, according to claim 52, wherein said substrate is a wood material having the shape of at least one of a board or a plate, said board or plate having at least one of a narrow side or edge.

54. The article of manufacture, according to claim 53, wherein said plate is a device selected from the group consisting of a clamping plate, a pressboard plate, and a median thickness fiber plate.

55. The article of manufacture, according to claim 54, wherein said extruded billet is adhered to said narrow side or edge.

56. A method of joining a synthetic extrudate to a material surface, the method comprising:
providing a substrate having a billet-contact surface;
extruding a thermoplastic billet onto said surface; and pressing said billet onto said surface by a billet-shaping means.

57. The method of joining a synthetic extrudate to a material surface, according to claim 56, wherein said thermoplastic comprises a heat-setting polyurethane.

58. The method of joining a synthetic extrudate to a material surface, according to claim 56, wherein said thermoplastic further comprises additional polymers and additives.

59. An article of manufacture comprising:
a substrate having a billet-contact surface;
an extruded and shaped, thermoplastic polyurethane billet adhered to said surface by means of adhesive properties of said thermoplastic, wherein said billet is forced against said substrate by said shaping means substantially simultaneously as it is extruded.

60. The article of manufacture, according to claim 59, wherein said extruded billet comprises:
at least one heat-setting thermoplastic; and
particulate fillers.

61. The article of manufacture, according to claim 60, wherein said thermoplastic is selected from the group consisting of ethylene/vinyl acetate copolymers, polyamides, polyurethanes, polyolefins, and mixtures thereof.

62. The article of manufacture, according to claim 61, wherein said polyolefin is an amorphous poly-a-olefin.

63. The article of manufacture, according to claim 60, wherein said thermoplastic is a hot-melt adhesive.

64. The article of manufacture, according to claim 60, wherein said filler is selected from the group consisting of inorganic oxides, silicates, carbonates, and sulfates.

65. The article of manufacture, according to claim 60, wherein said particle is provided at from about 30% to about 80% by weight of total extrudate.

66. The article of manufacture, according to claim 60, wherein said particle is provided at from about 50% to about 70% by weight of total extrudate.

67. The article of manufacture, according to claim 60, wherein the shape of said particle is selected from the group consisting of substantially rod and substantially spherical shapes.

68. The article of manufacture, according to claim 60, wherein said particle has a median size of from about 3 micrometers to about 20 micrometers.

69. The article of manufacture, according to claim 60, wherein said particle has a median size of from about 4 micrometers to about 10 micrometers.

70. The article of manufacture, according to claim 60, further comprising at least one additive selected from the group consisting of resins, aromatic hydrocarbon resins, modified synthetic resins, liquid rosin resins, waxes, auxiliary agents, and combinations thereof.

71. The article of manufacture, according to claim 60, wherein said billet is provided a three-dimensional profile.

72. A method of joining a synthetic extrudate to a material surface, the method comprising:
providing a substrate having a billet-contact surface;
extruding a thermoplastic billet onto said surface; and pressing said billet onto said surface by a billet-shaping means.

73. The method of joining a synthetic extrudate to a material surface, according to claim 72, wherein said thermoplastic comprises a heat-setting material selected from the group consisting of ethylene/vinyl acetate copolymers, polyamides, polyurethanes, polyolefins, and mixtures thereof.

74. The method of joining a synthetic extrudate to a material surface, according to claim 73, wherein said polyolefin is an amorphous poly-α-olefin.

75. The method of joining a synthetic extrudate to a material surface, according to claim 72, wherein said thermoplastic is a hot-melt adhesive.

76. The method of joining a synthetic extrudate to a material surface, according to claim 72, wherein said thermoplastic further comprises particulate fillers.

77. The method of joining a synthetic extrudate to a material surface, according to claim 76, wherein said filler is selected from the group consisting of inorganic oxides, silicates, carbonates, and sulfates.

78. The method of joining a synthetic extrudate to a material surface, according to claim 76, wherein said particle is provided at from about 30% to about 80% by weight of total extrudate.

79. The method of joining a synthetic extrudate to a material surface, according to claim 76, wherein said particle is provided at from about 50% to about 70% by weight of total extrudate.

80. The method of joining a synthetic extrudate to a material surface, according to claim 76, wherein the shape of said particle is selected from the group consisting of substantially rod and substantially spherical shapes.

81. The method of joining a synthetic extrudate to a material surface, according to claim 76, wherein said particle has a median size of from about 3 micrometers to about 20 micrometers.

82. The method of joining a synthetic extrudate to a material surface, according to claim 76, wherein said particle has a median size of from about 4 micrometers to about 10 micrometers.

83. The method of joining a synthetic extrudate to a material surface, according to claim 76, further comprising at least one additive selected from the group consisting of resins, aromatic hydrocarbon resins, modified synthetic resins, liquid rosin resins, waxes, auxiliary agents, and combinations thereof.

84. An article of manufacture comprising a three-dimensional, extruded and shaped profile adhered to a substrate, wherein said profile comprises a homogeneous heat-setting thermoplastic.

85. The article of manufacture, according to claim 84, wherein said profile comprises comprises:
at least one heat-setting thermoplastic; and
particulate fillers.

86. The article of manufacture, according to claim 84, wherein said thermoplastic is selected from the group consisting of ethylene/vinyl acetate copolymers, polyamides, polyurethanes, polyolefins, and mixtures thereof.

87. The article of manufacture, according to claim 84, wherein said polyolefin is an amorphous poly-α-olefin.

88. The article of manufacture, according to claim 85, wherein said thermoplastic is a hot-melt adhesive.

89. The article of manufacture, according to claim 85, wherein said filler is selected from the group consisting of inorganic oxides, silicates, carbonates, and sulfates.

90. The article of manufacture, according to claim 85, wherein said particle is provided at from about 30% to about 80% by weight of total extrudate.

91. The article of manufacture, according to claim 85, wherein said particle is provided at from about 50% to about 70% by weight of total extrudate.

92. The article of manufacture, according to claim 85, wherein the shape of said particle is selected from the group consisting of substantially rod and substantially spherical shapes.

93. The article of manufacture, according to claim 85, wherein said particle has a median size of from about 3 micrometers to about 20 micrometers.

94. The article of manufacture, according to claim 85, wherein said particle has a median size of from about 4 micrometers to about 10 micrometers.

95. The article of manufacture, according to claim 85, further comprising at least one additive selected from the group consisting of resins, aromatic hydrocarbon resins, modified synthetic resins, liquid rosin resins, waxes, auxiliary agents, and combinations thereof.

96. The article of manufacture, according to claim 85, wherein said billet is provided a three-dimensional profile.

97. A method of consolidating elongate members, the method comprising:
providing at least first and second elongate members wherein each said member has at least one of a narrow side and edge;
applying a layer of a thermosetting plastic to said narrow side or edge; and
contacting said narrow side or edge of a first elongate member with said narrow side or edge of said second elongate member.

98. The method of consolidating elongate members, according to claim 97, wherein said thermoplastic is selected from the group consisting of ethylene/vinyl acetate copolymers, polyamides, polyurethanes, polyolefins, and mixtures thereof.

99. The method of consolidating elongate members, according to claim 97, wherein said polyolefin is an amorphous poly-α-olefin.

100. The method of consolidating elongate members, according to claim 97, wherein said filler is selected from the group consisting of inorganic oxides, silicates, carbonates, and sulfates.

101. The method of consolidating elongate members, according to claim 97, wherein said particle is provided at from about 30% to about 80% by weight of total extrudate.

102. The method of consolidating elongate members, according to claim 97, wherein said particle is provided at from about 50% to about 70% by weight of total extrudate.

103. The method of consolidating elongate members, according to claim 97, wherein the shape of said particle is selected from the group consisting of substantially rod and substantially spherical shapes.

104. The method of consolidating elongate members, according to claim 97, wherein said particle has a median size of from about 3 micrometers to about 20 micrometers.

105. The method of consolidating elongate members, according to claim 97, wherein said particle has a median size of from about 4 micrometers to about 10 micrometers.

106. The method of consolidating elongate members, according to claim 97, further comprising at least one additive selected from the group consisting of resins, aromatic hydrocarbon resins, modified synthetic resins, liquid rosin resins, waxes, auxiliary agents, and combinations thereof.

107. An article of manufacture comprising:
a substrate comprising at least one elongated member having at least one of a narrow side or edge; and
a substantially uniform layer of a homogeneous material applied to said narrow side or edge.

108. The article of manufacture, according to claim 107, wherein said substrate comprises wood and wherein said narrow side or edge is porous.

109. The article of manufacture, according to claim 108, wherein said homogeneous material is forced into said pores of said substrate.

110. The article of manufacture, according to claim 107, wherein said homogeneous material comprises a thermoplastic selected from the group consisting of ethylene/vinyl acetate copolymers, polyamides, polyurethanes, polyolefins, and mixtures thereof.

111. The article of manufacture, according to claim 107, wherein said polyolefin is an amorphous poly-α-olefin.

112. The article of manufacture, according to claim 107, method of consolidating elongate members, wherein said filler is selected from the group consisting of inorganic oxides, silicates, carbonates, and sulfates.

113. The article of manufacture, according to claim 107, method of consolidating elongate members, wherein said particle is provided at from about 30% to about 80% by weight of total extrudate.

114. The article of manufacture, according to claim 107, method of consolidating elongate members, wherein said particle is provided at from about 50% to about 70% by weight of total extrudate.

115. The article of manufacture, according to claim 107, method of consolidating elongate members, wherein the shape of said particle is selected from the group consisting of substantially rod and substantially spherical shapes.

116. The article of manufacture, according to claim 107, method of consolidating elongate members, wherein said particle has a median size of from about 3 micrometers to about 20 micrometers.

117. The article of manufacture, according to claim 107, method of consolidating elongate members, wherein said particle has a median size of from about 4 micrometers to about 10 micrometers.

118. The article of manufacture, according to claim 107, method of consolidating elongate members, further comprising at least one additive selected from the group consisting of resins, aromatic hydrocarbon resins, modified synthetic resins, liquid rosin resins, waxes, auxiliary agents, and combinations thereof.

119. The article of manufacture, according to claim 107, method of consolidating elongate members, wherein said thermoplastic is a hot-melt adhesive.

120. The article of manufacture, according to claim 107, method of consolidating elongate members, wherein said thermoplastic material further comprises materials selected from the group consisting of wetting agents, thickening agents, fillers, crosslinking agents, resins, waxes, and silicic acid.
